(19) United States
(12) Patent Application Publication
(10) Pub. No.: US 2026/0087375 A1
(43) Pub. Date: Mar. 26, 2026

(54) Decision Tree Algorithms in Machine Learning To Learn and To Predict Innovations

(71) Applicant: Marguerite Johnson, Bloomfield Hills, MI (US)

(72) Inventor: Marguerite Johnson, Bloomfield Hills, MI (US)

(21) Appl. No.: 19/253,892

(22) Filed: Jun. 29, 2025

Related U.S. Application Data
(63) Continuation-in-part of application No. PCT/US2022/000013, filed on Jul. 19, 2022.

(30) Foreign Application Priority Data
Jul. 19, 2022 (US) 17/803451

(51) Int. Cl. G06N 5/01

(52) U.S. Cl. CPC G06N 5/01

(57) ABSTRACT

An expert system for innovation discovery in the field of artificial intelligence (AI) applies decision tree algorithms structured around a rules-based reasoning methodology. The system trains on innovation datasets comprising both data and non-data types, including target variables representing key attributes of innovations and proximal variables that approximate them. Through a machine learning architecture, decision nodes are configured to evaluate these variables and generate predictive models. The architecture enables continual learning via reinforcement mechanisms and communication ports that facilitate data flow from external tools, cloud storage, and software. Differentiated nodes are assigned weights, roles, and activation logic to refine decision-making and improve model accuracy. The expert system integrates human-defined heuristic rules with AI capabilities to support early-stage ideation, concept development, and innovation pattern recognition. This system can operate as an autonomous AI agent, a core reasoning engine, or as part of a digital business model in platform ecosystems to enhance innovation discovery, reduce hallucinations, and support transparent, verifiable AI outcomes.

### BACKGROUND

Innovation has long been a priority for corporations, which justifies the high investment costs for research and development. A simple Internet search reveals tens of thousands of search results referencing “innovation”. There are global consulting firms (such as Mckinsey, Deloitte, and Boston Consulting Group), research institutions, and trade associations with exclusive practices to aide corporations in solving their challenges in innovation. Nevertheless, the challenges continue.

Innovation is a nonlinear iterative process that lacks a well-established unifying system—a repeatable lifecycle. And unfortunately, the available methods and information about innovation processes are disparate. This further complicates discovering newer innovations. Newer innovations (called “disruptive”) are dissimilar to existing domain knowledge, which means identifying them without expert guidance is frustrating. It could explain why research developers stay within their existing knowledge domains. Without a unifying system—a repeatable lifecycle—newer innovations outside of existing domain knowledge remains difficult to discover. The goal of this invention is to increase the chances of innovation discovery.

In the book, “Disruptive Innovation and Digital Transformation: 21^{st} Century New Growth Engines”, the author, Johnson documented observed phenomenon, “customer expectations”, from her research on disruptive innovation and digital capabilities to transform a business's products, service offerings, and business models. These “customer expectations” are one of many possible input variables an innovator could consider, and they are one of many categories that could be considered for innovation. But they are imprecise for the purposes of training a machine. But training machines was not the purpose of Johnson's book. It was for training humans; therefore, it identified six phases in a lifecycle that systematically determine when disruptive innovations are more likely to be discoverable, and she illustrated those phases, using a pattern: accessible, dependable, reliable, usable, delightful, and meaningfulness. Johnson labeled them as “disrupters” in a Pattern of Disruptions. Johnson's research revealed that these phases were impacted by key customer expectations. However, Johnson's book falls short of teaching or fairly suggesting Decision Tree Algorithms comprising: Target Variables defining key attributes of innovations that can be non-data and data types; and Proximal Variables are approximated attributes of Target Variables.

Unfortunately, neither the information in Johnson's book, investigations into AI business applications, nor innovation research, individually or in combination, could achieve the methodology in the patent claims. Nonetheless, Johnson's observed phenomenon research on innovation did alert and inspire her to investigate the field of Artificial Intelligence (AI) due to its ability to mine vast amounts of data, detect patterns, and process information. What Johnson found—in some of the more popular use cases of AI for business—was lacking. Even with access to large language models, using Generative AI (GenAI) and applied to a specific business task, such as strategy, AI struggles to compete with human experts. The tremendous capabilities of AI are insufficient without human experts, intervening with processes, rules, and systems. Therefore, the potential to apply AI's capabilities for innovation discovery were not completely dismissed—particularly in the early phases of creating new ideas, which generally starts with brainstorming activities.

### Limitations of Performance by Humans and Systems

There are aspects of creating ideas in an innovation process that can be helped by AI, and then there are others that can worsen matters, such as AI's tendency to hallucinate. Also, AI systems could stall due to a lack of consistent, relevant, and reliable new data to train and to learn, effectively failing to improve its performance. Regardless of the level of expertise or knowledge, there are limits to what humans can know during the process of innovation discovery—particularly in areas where new knowledge exists that is outside of a human's expertise. This reality is worsened when the lack of a systematic lifecycle for innovation discovery is combined with the rise of AI for business applications in its current state.

Furthermore, in the absence of a memory to store and retain the machine's data, information, processes, and validated outcomes, new inputs could override them, rendering the machine in a state of perpetual change, unstable and unreliable.

The above limitations have been thoughtfully considered, and this invention is designed to remedy most. For instance, this invention is designed for continual refreshes of data into the machine to create a perpetual state of learning through reinforcement, escaping conditions associated with hallucinating, e.g. “stale” data that leads to poor training, quality, and diminished performance. It trains on innovation data (as in Claim 1), using decision tree algorithms (“if-then” statements) created by human experts as “rules” for problem solving, heuristic processes or methods, such as by human practitioners, experts in problem-solving, and scientists, or product feature specifications, or alerts for thresholds to meet safety standards and regulations, or guidelines for innovation management, or project performance benchmarks, including financial metrics)—and it receives data through “ports”, connecting the machine to tools, software, cloud data storage for memory, and third party resources. The interactions between Claim 1 and Claim 25 brings together data, tools, and inputs inside a closed loop ecosystem for exchanges and refinements between two sides: one side for training data and the other side for external inputs (e.g. tools, software, data, etc.).

Decision tree methods for machine learning in predictive modeling draw conclusions about a set of observations. They do not independently address innovation discovery or the impacts on business viability, such as when applied to end-user consumer markets/applications. These require reasoning for decision-making. And this is one of the focus areas of this patent. The other focus area is the general field of Artificial Intelligence (AI) systems.

### How are the Decision Trees Trained and What is Meant by the Designations of Non-Data and Data Types that Generate Predictive Models in the Patent Claims

This unique system design achieves a meaningful focused machine learning architecture to train the decision tree algorithms: rules (“if-then” statements) that are directed by humans, knowledge domains, and parameters; decisions are then distributed through configured differentiated nodes (pathways) that are guided by variables and their relationships to innovation datasets, such as non-data types (e.g., graphics, videos, formulas, symbols, mathematical expressions, etc.) and data types (e.g., numbers, digits, codes, alpha-numeric, text, counts, volumes, etc.). There is an additional layer of external data from partners that provide relevant new data to reinforce learning to improve the AI system's performance via computer network communication (such as in Claim 25 using “ports”). Innovation datasets regardless of structure can contain data inputs having a broad range of formats and combinations. These datasets can be on local servers, remote data warehouses, or external data (e.g. cloud services). Predictive models are outcomes generated, because of the machine's architecture: inputs (data and human experts), decision trees (“if-then” statements that are human heuristic “rules”), differentiated nodes (pathways of decisions), and reinforced learning (continual learning).

### How are Key Attributes of Innovations Determined that Generate Predictive Models in the Patent Claims

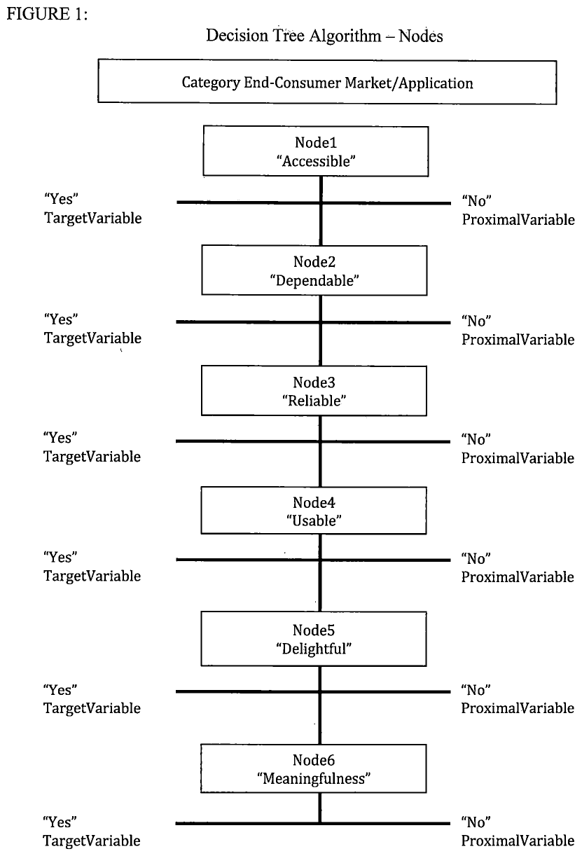

The AI expert system starts by narrowing the knowledge domain, using “Category End-Consumer Market/Application” as shown in FIG. 1, derived from Categories and classifications of innovations, then uses rules-based reasoning, “if-then” statements through decision tree algorithms (“rules” that sort, classify, describe Target Variables and Proximal Variables based on their Key Attributes. Key Attributes are identifiers (such as keywords, tags, labels, characteristics or other distinguishing parameters) that locate Target Variables inside innovation datasets, innovations in categories, and/or innovations in classifications, as in Claims 1-6, e.g. using its dimensions, materials, compositions, features, descriptions, characteristics, markets, products, customers, suppliers, partners, etc. and/or its Proximal Variables, e.g. such as size, application, color, weight, scale, image, contact information, etc.), and configurable differentiating nodes to split decision making into multiple pathways and to generate predictive models by collecting and preprocessing data, based on defined parameters and attributes, and building decision tree models.

### What Exactly are the Categories and Classifications of Innovations, how are they Derived from Data, and how do they Differ (Target and Proximal Variables)

“Categories and classifications of innovations” (as in Claims 1 and 25) are different from classifications, distribution, sorting, describing, and categorizing of data by decision tree algorithms. Also, they are different from Target Variables and Proximal Variables. “Categories and classifications of innovations” are derived from naming conventions used by business, government, and industry to group relevant information to describe business, technology, industry, market, end-user, application, and/or product. They can be created or derived from industry standards, such as North American Industry Classification System (NAICS) or patent classifications. They help humans recognize and standardize relevant datasets across a range of sources.

### FIELD OF INVENTION

More broadly speaking, in the field of AI, a rules-based reasoning methodology based in domain specific expert knowledge can be referred to as an “expert system”. This patent fits into the AI field of an expert system in the application of innovation discovery enabled with a rules-based reasoning process. It derives its decision-making capabilities from a set of prewritten rules (designed into its Decision Tree algorithms—mostly defined by “if-then” statements) that classify variables and distribute to configurable differentiated nodes to generate models.

### Example: How a Person Interacts with a Computer that is Enabled with Communications Via Ports to AI Software and Tools, Recognizing Inputs From “Person or a System”

In a limited example of this patent's expert system, while communicating via ports (as in Claim 25) with AI software (e.g., prompt engineering) and AI technologies (e.g., retrieval augment generation), humans can input prompts to search data contained in predictive models and to retrieve references to datasets contained in outputs from predictive models: such as Target Variables and Proximal Variables contained in innovation databases, e.g., historical records, specifications, reports, analyses, relationships, adjacencies, applications, products, business models, patent applications, systems, components, and other sources, all of which contain variables, such as dimensions, materials, parameters or tolerances, artifacts, replicas, illustrations, drawings, sketches, and composites.

### Example: How is a Person Aided by a Computer, Recognizing a “Person or a System”

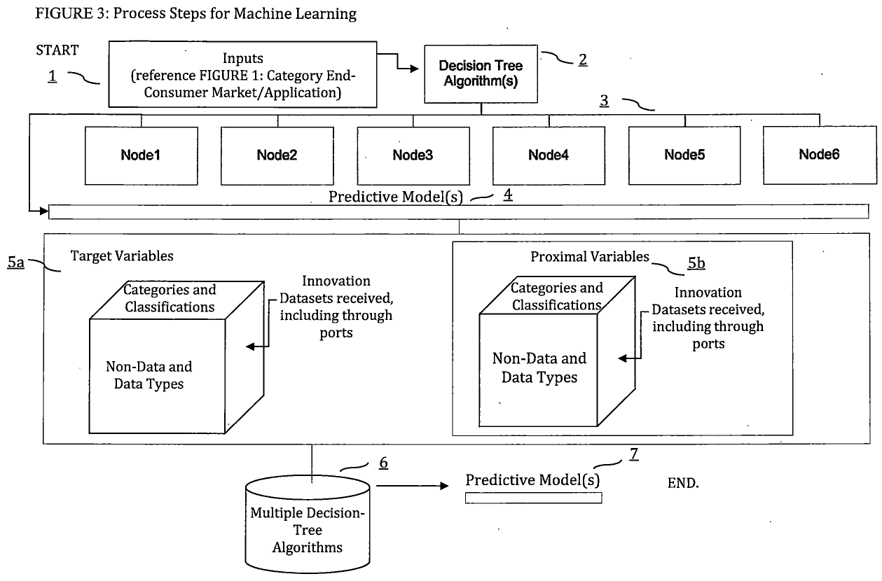

Combined with human expert “rules” and inputs, the expert system enables transparency by design. The expert system's process steps are detailed in FIG. 3 and described with references to specific claims below:

Claims 1-11; 13-17; 20-41; and 44-48 details the rules-based machine learning architecture and processes for Decision Trees, which begins with Claim 1: “Trains on innovation datasets containing Categories and Classifications that can be non-data and data types; Target Variables defining key attributes of innovations that can be non-data and data types; Proximal Variables are approximated attributes of Target Variables; and Nodes that are configured to train and create predictive models.” Absent the rules-based methodology contained in Claims 1-11; 13-17; 20-41; and 44-48, Decision Trees cannot discover innovations.

In addition, FIG. 1 specifies how differentiating nodes are split by a Decision Tree, based on the rules-based reasoning (“if-then” statements) that occurs between “TargetVariable” and “Proximal Variable”, which begins in Claim 1: “ . . . Target Variables defining key attributes of innovations that can be non-data and data types; Proximal Variables are approximated attributes of Target Variables . . . ”

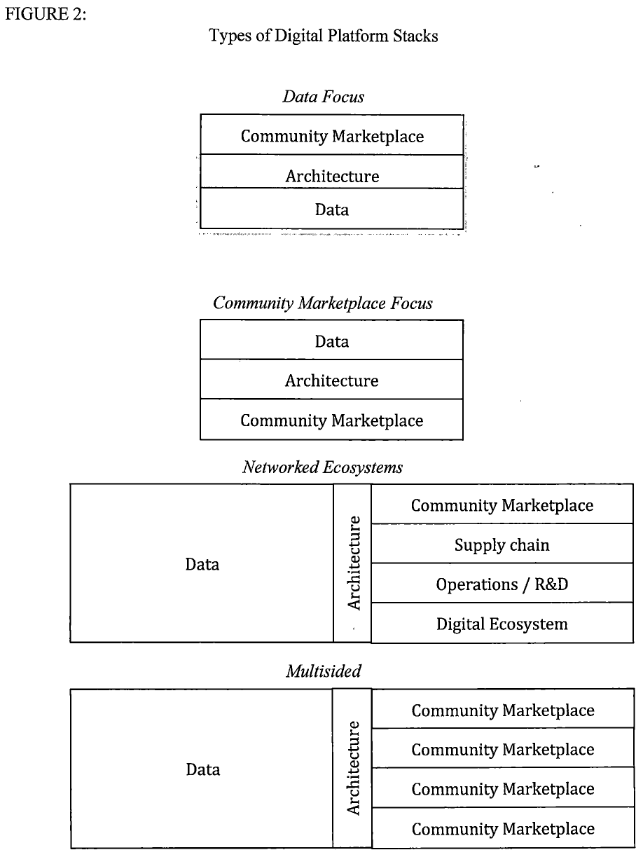

Furthermore, FIG. 2 details in which focused digital business operating environments facilitate reinforce learning inside digital platform stacks: Data Focus, Community Marketplace Focus, Networked Ecosystems, and Multisided Network Ecosystems. These focused environments are detailed in Claims 22, 23 and 24, and Claims 46, 47 and 48.

### Example: How Humans and Computers are Enabled by the Machine Learning Process, Architecture and Communications with Computer Networks to Achieve the Limitations in the Claims

The expert system can enable reasoning within a broader context for an AI system to autonomously make decisions, to act or to adapt, and to perform capabilities and functionalities with guidance from human experts. For instance, it is reasonable to understand how the expert system for innovation discovery can communicate via ports with AI software and technologies, such as natural language processing (NLP) to parse inputs from data “Category End-Consumer Market/Application”, “Classifications”, “Categories”, retrieval augmented generation (RAG) to extract information from “Innovation Datasets” for “Target Variables” and “Proximal Variables”, robot process automation (RPA) or Generative Pre-trained Transformer (GPT) to repeatably contribute to predictive model, or applications, such as support port inputs: Application Protocol Interface (API), image generators, Generative AI chatbots, and data, such as language models, libraries (text, audio, videos, images), technical dictionaries, databases and repositories of knowledge, or services, such as data, licenses, search engines, AI cloud infrastructure. With the addition of these capabilities, it is reasonable within the description, claims, and illustrations to interpret how an AI expert system can be advanced to act autonomously to learn and to predict innovation as an “AI Agent”, such as autonomous agents, interpretability agents, and multi-agent systems, using a rules-based reasoning process for decision-making for innovation discovery. In addition to enabling an AI Agent, the expert system can be networked to operate as a business model (revenue model), as such it can be used to facilitate transactions, interactions and engagements across providers, resellers, customers, and partners for data, services, and applications to enhance its capabilities. There are varieties of business model types, which are illustrated in FIG. 2 and in claims 22-24 and 46-48, that enable parties to sell (or exchange) data, services, and applications to support building features and functionalities that enhance the expert system (or as an AI Agent). These increase the number of configurations and options for a business to customize an expert system specifically for its operations and innovation goals, or to discover innovation revenue streams.

Whether the expert system operates as a business model, an AI Agent, or an internal innovation system, embodiments in this patent describe and illustrate an AI expert system for innovation that has a rules-based methodology for making decisions, using a set of prewritten rules to reason (Decision Tree algorithms), an orderly process for machine learning, and the application of AI to innovation discovery. It contributes to the field of AI in machine learning, expert systems, and agents to advance human abilities to discover and to explore ideas, concepts, and innovations. Also, this expert system embodies transparency in the training of machines. In the absence of a clearly defined process, human experts would struggle to interpret recommendations for ideas, concepts, and innovations derived from an AI system. An expert system, as claimed and described in this patent, is especially beneficial for humans to fact-check and to detect hallucinations and inaccuracies in AI systems (enabling human “Chain-of-Thought” prompting), as well as for humans to perform tests or experiments (enabling querying procedures “human-in-the-loop”).

### SUMMARY

An expert system in the field of Artificial Intelligence (AI) that uses machine learning Decision Tree algorithms to perform a set of prewritten rules to reason through decision nodes that split according to relationships between variables and innovation datasets to train and to learn on domain specific and relevant knowledge for humans to advance discovery of innovations, generate ideas, develop new concepts, designs, and the exploration of new insights inside a systematic process workflow that sequences and combines models and algorithms inside a transparent architecture to generate predictive models. When combined with AI software, technologies, or applications it can perform the function of a core reasoning engine for an AI system, as well as for an AI agent to autonomously perform tasks, act or adapt, directed by human experts, or a business model.

### DETAILED DESCRIPTION OF THE DRAWINGS AND CORRESPONDING CLAIMS

For the purposes of understanding, specific embodiments are illustrated in drawings and cross-referenced with claim numbers. The drawings depict a typical, but limited, scope for the purposes of illustrating claims:

FIG. 1: is a process step diagram of the Decisioning Framework for Decision Tree Algorithm—Nodes that begins by first selecting the specific knowledge domain from “Category End-Consumer Market/Application”. This prioritization establishes the parameters for Nodes, as in Claims 8, 9, 32, and 33. Nodes are configured to evaluate Target Variables and Proximal Variables. These variables influence decision-making. “Nodes that are configured to train and create predictive models”, as in Claims 1 and 25.

### How is Reinforce Learning Combined with Decision Tree Algorithms, and how is a Decision Tree Algorithm Included in Digital Business Models, as the Decision Tree is Learning:

Unlike FIG. 1 and FIG. 3, FIG. 2 is a framework for digital business models and networking in Types of Digital Platform Stacks, such as network ecosystems, marketplaces, and data. It is not a decision tree. It solves a key problem in machine learning, “stale data”. To be effective and to improve performance, computers need constant refreshes of data to train and to learn. This is accomplished by enabling active communications “ports” to maintain connections to networks of relevant data, software, and technologies. The system gains access to an ecosystem of networks, having their own data, to continually reinforce learning. Both the title of FIG. 2 and the prescribed tiered stacks are intentional.
A common-use definition relevant to interpreting the patent claims and illuminate the architecture, mechanisms, and capabilities of a digital platform stack for the purposes of the patent application: “Platform Stacks” are metaphors for visualizing a technology's architectural layers.

To effectuate reinforced learning in this unique system design requires knowledge in digital business design to fully appreciate how patent Claims 1 and 25 complement one another, i.e. both sides of a solution. For example, Claim 25: “Decision Tree Algorithms comprising: Categories and Classifications of innovation information received through ports; Target Variables defining key attributes of innovations that can be non-data and data types; Proximal Variables are approximated attributes of Target Variables; and Nodes that are configured to train and create predictive models” provides for communications (“ports”) between external computers, software, applications, hardware, networks, and systems with the Claim 1: “Decision Tree Algorithms comprising: Training the decision tree on datasets containing categories and classifications that can be non-data and data types; Target Variables defining key attributes of innovations that can be non-data and data types; Proximal Variables are approximated attributes of Target Variables; and Nodes that are configured to train and create predictive models”.

For example, a company operating from the side of “Claim 1” could directly receive data designated to its ports (e.g. computer networking) from the side of “Claim 25”, a data analytics seller, a customer data partner, an API (Application Programming Interface) visualization developer, or other data services. These transactions can be episodic or repeat, as part of a purchase or a contract. Both sides interact: “Claim 1” and “Claim 25”. Johnson provides for a range of stack architectures to illustrate this point in FIG. 2, where multiple parties interacting and digital platform business model with networked ecosystems of parties interacting.
The labels in FIG. 2 illuminate the digital platform business operating environments, where multiple parties interacting and digital platform business model with networked ecosystems of parties interacting primarily across functionalities contained in Claims 1 and 25.
Below are common-use definitions and examples that are relevant to interpret the patent claims and to illuminate how this architecture and mechanisms serve the purposes of reinforce learning, as well as transactional exponential value creation (“network effects”: with every additional user added to the platform value is created for all users)—only capable through a digital platform stack design:
   “Marketplaces”: this digital business environment brings together consumers and producers to purchase goods, services, and other types of transactions directed by a company (e.g. Amazon's ecommerce platform).
   “Data Exchanges”: this digital business environment hosts the platform and charges approved sellers'fees on transactions (e.g. Bloomberg or Salesforce).
   “Networked Ecosystems”: this digital business environment provides infrastructure and technology “walled garden” that directs developers, buyers and approved resellers (e.g. Apple's iOS).

The goal for this patent is to advance innovation, and therefore it identifies the focused areas for digital business operating environments, as in Claims 22-24 and 46-48, where Decision Tree algorithms perform their functionalities in a digital platform business model for reinforce learning.

FIG. 3: is a diagram of the Process Steps for Machine Learning in a workflow from “start-to-end”:
(1) “Starting” with a typical input source for innovations from ports, (claim 25), such as in FIG. 1: Category End-Consumer Market/Application.
(2) using machine learning to develop how a computer trains itself to generate information, Decision Tree algorithms can train and learn from observations and classify inputs into differentiating Nodes (using reinforced learning and training on datasets and deep learning and practicing on datasets, as in Claims 20-21 and 44-45).

### How are Differentiated Nodes Configured to Train and How are They Different from Nodes in the Decision Tree

The patent claims establish a machine learning process that utilizes two types of nodes to achieve an outcome that is intentionally performing certain functions. This transparent architecture is a key element in the patent claims:
Base: Decision Tree Nodes, as detailed in claims 1-6 and 25-30. These are rules-based (“if-then” statements) for actions, such as data classification, distribution, sorting, describing, and categorizing, i.e., part of the hierarchical structure of decision points and branches “nodes”. They are primarily dependent upon “rules”defined and inputted by humans.
Secondary: Differentiating Nodes, as detailed in patent claims 8-17 and 32-41. Differentiated by their role, function, and the connections they have with other nodes. They are primarily fixed and applied systemwide. Configurations can be achieved by assigning different weights and biases to nodes, allowing them to specialize by their role (e.g., observations, detections, and/or patterns) and their activation functions (e.g., independent, intersecting, and/or conditional). They are detailed below and illustrated in FIG. 3:
(3) Nodes play a critical role in machine learning, which is why the patent includes multiple descriptions of their attributes, behaviors, and configurations to evaluate variables, as in Claims 1; 8-11, and 13-17; 25; 32-41. The below is how nodes are configured to multiple decision tree algorithms:
   Nodes can be defined or approximated parameters.
   Nodes can be independent, intersecting, and/or conditional.
   Nodes can be configured in a specific order of operation.
   Nodes can be configured to maintain a specific order throughout cycles.
   Nodes can be configured to follow a specific pattern.
(4) Nodes can create predictive models, as in Claims 1 and 25.
(5a) Nodes can intersect (e.g. cross-reference) Target Variables: defining key attributes of innovations that can be non-data and data types, as well as innovations in categories and innovations in classifications, as in Claims 2-3 and 26-27; and (5b) Proximal Variables: are approximated attributes of Target Variable, as well as innovations in categories and innovations in classification, as in Claims 4-5 and 28-29. These Nodes are derived from sets of observations Decision Tree algorithms make when they are trained on datasets that can be non-data and data types and Categories and Classifications of innovation information received through ports, such as computers and networks, as in Claims 1 and 25.
(6) Nodes can be configured to multiple Decision Tree algorithms, as in Claims 14 and 36, in addition to the configurations referenced in (3).
(7) Ending with predictive model/(s) that can be combined, such as the predictive models created by Nodes or other predictive models, as in Claims 7 and 31. There are two types of predictive models: Nodes (referenced in (3)) and Nodes that intersect (e.g. cross-reference) Target Variables and Proximal Variables that are innovations in classifications and innovations in categories (reference in (5a) and (5b)) that can be generated by machine learning in this process workflow.

1. Decision Tree Algorithms comprising:
Training the decision tree on datasets containing categories and classifications that can be non-data and data types;
Target Variables defining key attributes of innovations that can be non-data and data types;
Proximal Variables are approximated attributes of Target Variables; and
Nodes that are configured to train and create predictive models.

2. Decision Tree Algorithms in claim 1, wherein Target Variables are innovations in categories.

3. Decision Tree Algorithms in claim 1, wherein Target Variables are innovations in classifications.

4. Decision Tree Algorithms in claim 1, wherein Proximal Variables are innovations in categories.

5. Decision Tree Algorithms in claim 1, wherein Proximal Variables are innovations in classifications.

6. Decision Tree Algorithms in claim 1, wherein Proximal Variables share attributes with Target Variables.

7. Decision Tree Algorithms in claim 1, wherein predictive models can be combined.

8. Decision Tree Algorithms in claim 1, wherein Nodes have defined parameters.

9. Decision Tree Algorithms in claim 1, wherein Nodes have approximated parameters.

10. Decision Tree Algorithms in claim 1, wherein Nodes are in a specific order of operation.

11. Decision Tree Algorithms in claim 1, wherein Nodes maintain specific order throughout cycles.

12. Decision Tree Algorithms in claim 1, further comprising Nodes that are configured to multiple decision tree algorithms.

13. Decision Tree Algorithms in claim 1, further comprising Nodes that are configured to follow a specific pattern.

14. Decision Tree Algorithms in claim 1, further comprising Nodes that are configured to multiple decision tree algorithms.

15. Decision Tree Algorithms in claim 1, further comprising Nodes that intersect Target Variables and Proximal Variables.

16. Decision Tree Algorithms in claim 1, further comprising Nodes that can be independent.

17. Decision Tree Algorithms in claim 1, further comprising Nodes that can be conditional.

18. Decision Tree Algorithms in claim 1, further comprising an encoder that encrypts the datasets and models.

19. Decision Tree Algorithms in claim 1, further comprising a decoder configured to decipher the encoder.

20. Decision Tree Algorithms in claim 1, further comprising reinforced learning and training on datasets.

21. Decision Tree Algorithms in claim 1, further comprising deep learning and practicing on datasets.

22. Decision Tree Algorithms in claim 1, therein perform their functionalities in a digital platform business model.

23. Decision Tree Algorithms in claim 14, further comprising a digital platform business model with multiple parties interacting.

24. Decision Tree Algorithms in claim 14, further comprising a digital platform business model with networked ecosystems of parties interacting.

25. Decision Tree Algorithms comprising:
Categories and Classifications of innovation information received through ports;
Target Variables defining key attributes of innovations that can be non-data and data types;
Proximal Variables are approximated attributes of Target Variables; and
Nodes that are configured to train and create predictive models.

26. Decision Tree Algorithms in claim 25, wherein Target Variables are innovations in categories.

27. Decision Tree Algorithms in claim 25, wherein Target Variables are innovations in classifications.

28. Decision Tree Algorithms in claim 25, wherein Proximal Variables are innovations in categories.

29. Decision Tree Algorithms in claim 25, wherein Proximal Variables are innovations in classifications.

30. Decision Tree Algorithms in claim 25, wherein Proximal Variables share attributes with Target Variables.

31. Decision Tree Algorithms in claim 25, wherein predictive models can be combined.

32. Decision Tree Algorithms in claim 25, wherein Nodes have defined parameters.

33. Decision Tree Algorithms in claim 25, wherein Nodes have approximated parameters.

34. Decision Tree Algorithms in claim 25, wherein Nodes are in a specific order of operation.

35. Decision Tree Algorithms in claim 25, wherein Nodes maintain specific order throughout cycles.

36. Decision Tree Algorithms in claim 25, further comprising Nodes that are configured to multiple decision tree algorithms.

37. Decision Tree Algorithms in claim 25, further comprising Nodes that are configured to follow a specific pattern.

38. Decision Tree Algorithms in claim 25, further comprising Nodes that are configured to multiple decision tree algorithms.

39. Decision Tree Algorithms in claim 25, further comprising Nodes that intersect Target Variables and Proximal Variables.

40. Decision Tree Algorithms in claim 25, further comprising Nodes that can be independent.

41. Decision Tree Algorithms in claim 25, further comprising Nodes that can be conditional.

42. Decision Tree Algorithms in claim 25, further comprising an encoder that encrypts the datasets and models.

43. Decision Tree Algorithms in claim 25, further comprising a decoder configured to decipher the encoder.

44. Decision Tree Algorithms in claim 25, further comprising reinforced learning and training on datasets.

45. Decision Tree Algorithms in claim 25, further comprising deep learning and practicing on datasets.

46. Decision Tree Algorithms in claim 25, therein perform their functionalities in a digital platform business model.

47. Decision Tree Algorithms in claim 36, further comprising a digital platform business model with multiple parties interacting.

48. Decision Tree Algorithms in claim 36, further comprising a digital platform business model with networked ecosystems of parties interacting.
